(19) United States
(12) Patent Application Publication
(10) Pub. No.: US 2026/0260110 A1
(43) Pub. Date: Sep. 3, 2026

(54) METHOD OF PREDICTING WATER ENVIRONMENTAL CONDITIONS

(71) Applicant: DISNEY ENTERPRISES, INC., Burbank, CA (US)

(72) Inventors: Gregory Brooks Hale, Orlando, FL (US); Gary David Markowitz, San Juan Capistrano, CA (US); David Benson Gilmore, Orlando, FL (US)

(21) Appl. No.: 19/529,495

(22) Filed: Feb. 4, 2026

Related U.S. Application Data
(60) Provisional application No. 63/753,500, filed on Feb. 4, 2025.
(60) Provisional application No. 63/941,907, filed on Dec. 16, 2025.

(51) Int. Cl. G06N 3/08; G06N 3/0464; G06N 3/0475; G06N 3/0499

(52) U.S. Cl. CPC G06N 3/08; G06N 3/0464; G06N 3/0475; G06N 3/0499

(57) ABSTRACT

A method of predicting a localized climate condition includes: receiving, by a processing element, regional environmental data; translating, by the processing element by utilizing a water environment machine learning model, the regional environmental data into the localized climate condition; and generating, by the processing element, an alert based to the localized climate condition.

### CROSS REFERENCE TO RELATED APPLICATIONS

This application claims the benefit of priority under 35 U.S.C. § 119(e) and 37 C.F.R. § 1.78 to U.S. Provisional Patent Application No. 63/941,907 filed on Dec. 16, 2025, titled “METHOD OF PREDICTING WATER ENVIRONMENTAL CONDITIONS,” and to U.S. Provisional Patent Application No. 63/753,500 filed on Feb. 4, 2025, titled “METHOD OF PREDICTING WATER ENVIRONMENTAL CONDITIONS,” and is related to U.S. patent application Ser. No. 18/590,363 filed on Feb. 28, 2024, titled “METHOD OF PREDICTING MICROCLIMATE CONDITIONS BASED ON GLOBAL WEATHER,” all of which are hereby incorporated by reference herein in their entireties.

### BACKGROUND

Determining if the water and surf conditions at or adjacent to a body of water (e.g., a beach, lake, stream, river, sea, ocean, etc.) are safe for users such as beach goers and swimmers is a subjective process. Each body of water and shore of each body of water may have different characteristics such as the direction of surf orientation, tidal conditions, weather conditions, topography, and many other factors. There currently is no standard or approach for consistently forecasting or determining environmental water (e.g., surf or shore) conditions.

There are no systems available for capturing variations in water weather conditions on a local level nor in real time. Water safety personnel such as lifeguards manually assess, report, and respond to weather conditions and incidents. This process is not a prediction, but merely an observation of current conditions and may occur too late for users to make appropriate decisions about use of water areas. Furthermore, the condition observations may be generalized for large areas (e.g., an entire coastline, a city, a zip code, etc.) without taking into account the specific beach conditions and objective, measurable data that vary between beaches or even specific portions of the same beach (coastal areas). Where manual observations are used in forecasting, the results are often inaccurate due to the subjective nature of the manual observations, scarce, and involve too much of a time lag between observation and forecast to be useful for users of a body of water in real time. Moreover, the manual assessment may differ between lifeguards such that the same conditions may cause one lifeguard to issue a warning, while another lifeguard might not issue a warning.

### BRIEF SUMMARY

A method of predicting a localized climate condition includes receiving, by a processing element, regional environmental data; translating, by the processing element by utilizing a water environment machine learning model, the regional environmental data into the localized climate condition; and generating, by the processing element, an alert based on the localized climate condition.

Optionally, in some embodiments, the water environment machine learning model analyzes the regional environmental data and one or more localized climate area characteristics of a localized climate area to translate the regional environmental data into the localized climate condition for the localized climate area.

Optionally, in some embodiments, the localized climate condition includes one or more of: wave height, wave energy, wave frequency or periodicity, water and air temperature, rip current, undertow, tidal patterns, wind speed and direction, swell direction, water turbidity, salinity levels, ultraviolet (UV) radiation intensity, precipitation levels, seaweed presence, marine debris, marine life activity, water pH level, algae bloom occurrences, bacterial contamination risks, or storm surge.

Optionally, in some embodiments, the alert includes a mitigation action configured to mitigate effects of the predicted localized climate condition.

Optionally, in some embodiments, the alert includes a message configured to be displayed on a user device.

Optionally, in some embodiments, the regional environmental data includes at least one of a forecast or a regional weather condition.

Optionally, in some embodiments, the regional weather condition includes one or more of: a temperature, a heat exposure index, an insolation, a wind speed, a wind direction, a cloud cover, an atmospheric pressure, a precipitation amount, a wind chill, a dewpoint, a humidity, an atmospheric electrical field, a wind shear, an accumulated irradiation, a level of a pollutant, a level of a nutrient, or a phase of a celestial body.

Optionally, in some embodiments, the celestial body is the moon.

Optionally, in some embodiments, the regional weather condition includes a real time or near real-time condition.

Optionally, in some embodiments, the regional weather condition includes a historical condition.

Optionally, in some embodiments, the method further includes receiving, by the processing element, local weather data from a sensor located in the localized climate area.

Optionally, in some embodiments, the sensor is one or more of a land-based sensor, a buoy-based sensor, or an underwater sensor.

Optionally, in some embodiments, the water environment machine learning model includes an artificial intelligence or machine learning algorithm.

Optionally in some embodiments, the alert is based, at least in part, on a user's presence within a geofence area.

Optionally in some embodiments, the geofence is correlated to the localized climate area.

Optionally in some embodiments, the geofence travels with the user.

In one embodiment, a method of training a machine learning model includes receiving a regional environmental data for a localized climate area; detecting one or more localized climate conditions via one or more sensors positioned within the localized climate area; determining one or more localized environmental characteristics of the localized climate area at the time of the detected one or more localized climate conditions; generating the trained machine learning model based on the regional environmental data, the one or more localized climate conditions, and the one or more localized environmental characteristics.

Optionally, in some embodiments, the trained machine learning model analyzes the regional environmental data and one or more localized climate area characteristics of the localized climate area to translate the regional environmental data into the one or more localized climate conditions for the localized climate area.

Optionally, in some embodiments, the one or more localized climate conditions includes one or more of: wave height, wave energy, wave frequency or periodicity, water and air temperature, rip current, undertow, tidal patterns, wind speed and direction, swell direction, water turbidity, salinity levels, ultraviolet (UV) radiation intensity, precipitation levels, seaweed presence, marine debris, marine life activity, water pH level, algae bloom occurrences, bacterial contamination risks, or storm surge.

Optionally, in some embodiments, the regional environmental data includes at least one of a forecast or a regional weather condition.

Optionally, in some embodiments, the regional weather condition includes one or more of: a temperature, a heat exposure index, an insolation, a wind speed, a wind direction, a cloud cover, an atmospheric pressure, a precipitation amount, a wind chill, a dewpoint, a humidity, an atmospheric electrical field, a wind shear, an accumulated irradiation, a level of a pollutant, a level of a nutrient, or a phase of a celestial body.

Optionally, in some embodiments, the regional weather condition includes a real time or near real-time condition.

Optionally, in some embodiments, the regional weather condition includes a historical condition.

### BRIEF DESCRIPTION OF THE DRAWINGS

FIG. 1 is a schematic of a localized climate area including a shore area and a littoral area and portions of a water environmental prediction system.

FIG. 2 is a simplified schematic of an embodiment of a water environmental prediction system suitable for use with the localized climate area of FIG. 1.

FIG. 3 is a flowchart showing an example of a method of training a machine learning model of the water environmental prediction system of FIG. 2.

FIG. 4 is a flowchart showing an example of executing a machine learning model of the water environmental prediction system of FIG. 2 to predict a localized climate condition.

FIG. 5A is an example of a user interface of a user device of the water environmental prediction system of FIG. 2.

FIG. 5B is an example of an alert displayed by the user interface of the user device of the water environmental prediction system of FIG. 2.

FIG. 6 is a simplified schematic of an embodiment of the water environmental prediction system of FIG. 2.

FIG. 7 is a simplified block diagram of components of a computing system of the water environmental prediction system of FIG. 2.

### DETAILED DESCRIPTION

Embodiments of water environmental prediction systems disclosed herein predict localized climate conditions on or adjacent to bodies of water to help warn and mitigate the impacts thereof on people, animals, equipment, and devices. For example, when users are at a shore area such as a beach, the systems disclosed herein can alert the users of predicted conditions for the shore area or a littoral area near the shore.

The water environmental prediction systems disclosed herein can predict water environmental conditions such as wave height, wave energy, wave frequency or periodicity, water and air temperatures, the likelihood of conditions such as rip currents, undertow, tidal patterns, wind speed and direction, swell direction, water turbidity, salinity levels, ultraviolet (UV) radiation intensity, precipitation levels, seaweed presence, marine debris, jellyfish or marine life activity, water pH level, algae bloom occurrences, bacterial contamination risks, potential for storm surges, and/or combinations of these, or the like.
1. The water environmental prediction systems disclosed herein assist users such as lifeguards, beachside resort staff, coastal managers, cruise line crews, shore excursion operators, water sports enthusiasts (e.g., surfers, swimmers, kiteboarders, paddleboarders, kayakers, etc.), and others in making informed decisions about activities in the localized climate area. For example, the disclosed systems can deliver granular, advance forecasts that enable watercraft operators (e.g., cruise liner crews, ferry staff, and private boat crews, etc.) to make informed decisions about transporting users and to strategically plan travel routes and schedules to shore areas such as islands, ports, and beaches through adjacent littoral areas. Such planning incorporates expected changes in water conditions, wind, tides, and weather, allowing tour guides, emergency response teams, and passenger transport services to adjust timings, improve safety, and minimize service disruptions. The disclosed systems support safer and more efficient transportation, recreation, and commercial activity along coastlines in response to dynamic environmental factors.

Further still, marine researchers can use the data generated by the disclosed systems for ecological studies; event organizers can benefit when scheduling beachside activities or competitions; and local business owners, such as restaurants and equipment rental shops, can optimize their operations according to anticipated waterfront activity. Users are also empowered to assess safety, comfort, and travel plans for excursions within specific localized climate areas based on real-time and forecasted data.

In some embodiments, the disclosed systems use algorithms to continuously evaluate and predict the localized climate conditions which may be used by users such as beachgoers, swimmers, surfers, etc. The water environmental prediction systems may use current and historical regional environmental data e.g., from a forecast.

In some embodiments, the water environmental prediction systems may also use data from local sensors in the localized climate area, such as the shore area, the littoral area (above and/or under water), and/or both. The local sensors may be local area weather sensors, microclimate weather sensors, and or sensors that gather water/tidal/surf information from localized buoys. For example, the local sensors may measure the wave or wind velocity, direction, water and/or air temperature, wave height, wave periodicity, time of day, moon phases, tide tables, ocean current data, audio data from the surf/wind either above or below the water, etc. In some embodiments, the local sensors may include still and or video cameras and the water environmental prediction systems may also use photo/video analytics and observational/empirical data about the localized climate area. For example, where the local sensors include cameras, the cameras may be located on the shore and oriented to enable the capture of conditions in the water. In some embodiments, the local sensors may include specialized cameras such as cameras that can capture three-dimensional data such as light detection and ranging (LIDAR) sensors, depth cameras, or photogrammetry cameras. The local sensors may include an integrated network of buoys including onboard sensors, shore-specific microclimate stations, weather stations, and/or daily observational data provided by water safety personnel such as lifeguards. The local sensors capture localized atmospheric and oceanic data for localized climate condition prediction.

In some embodiments, the water environmental prediction system may include a machine learning model trained based on received data. The machine learning model may enable the system to predict localized climate conditions based on a macro or regional forecast. The machine learning model may also enable the system to provide alerts (e.g., real time alerts) based on actual water environmental conditions. Forecast and real time conditions can be used by the system to automatically trigger and send alerts via any electronic methods such as mobile devices, smart watches, flagging systems, public address systems, etc. In some embodiments, the machine learning model may enable the water environmental prediction system to correlate conditions on the surface of the water with conditions beneath the surface. For example, the machine learning model may be additionally trained on above or below-water topography for the localized climate area.

In some embodiments, the local sensor data may be correlated to human (e.g., lifeguard or beach manager) observations about or of the surf conditions and the outcomes of entering the water. In some embodiments, the water environmental prediction system may be trained on environmental conditions, the actual effect thereof on people, the microclimate within the localized climate area and the atmospheric conditions for the localized climate area. In some embodiments, the trained ML model can perform predictions in real time or near real time analysis without the use of local sensors, buoys, etc. For example, the trained ML model may perform predictions based on the regional environmental data without the use of local sensor data.

As used herein, a localized climate area is an area or region for which the water environmental prediction systems predict localized climate conditions. A body of water is any mass of moving or still water whether fresh, salt, or brackish. Examples of bodies of water include any of rivers, lakes, seas, oceans, ponds, streams, estuaries, bays, gulfs, straits, channels, fjords, reservoirs, wetlands, lagoons, inlets, coves, creeks, brooks, deltas, swamps, marshes, aquifers, tributaries, water tables, rapids, springs, canals, harbors, basins, sounds, sloughs, backwaters, and/or combinations of these.

A localized climate area may include a shore area. As used herein, a shore area is any area of land or structure adjacent to a body of water (e.g., a beach, tidal flat, coral reef, mangrove forest, coast, barrier island, estuarine shore, dune-backed beach, salt marsh or combinations of these.

A localized climate area may also include a littoral area. A littoral area refers to the part of a body of water close to the shore area. A littoral area is characterized by its dynamic nature and quickly changing conditions, influenced by tides, waves, floods, etc. In many locations a shore area and a littoral area may overlap.

Weather and water environmental phenomena are measured at various scales. Synoptic Scale meteorology refers to synoptic events occurring on a scale of thousands of kilometers, such as warm and cold fronts, typically on the order of greater than 1,000 miles (about 1,700 kilometers). Mesoscale meteorology refers to weather and water environmental systems smaller than synoptic-scale systems but larger than microscale and storm-scale systems. Mesoscale is between 1 and 1,000 miles (about 1.6 and 1,600 kilometers). Storm-scale meteorology is the study of cumulus systems larger than the microscale, but not large enough to be mesoscale systems. For example, cumulonimbus clouds vary in size and can typically range between one mile (about 1.6 kilometers) and 15 miles (24 kilometers). Microscale, microclimate meteorology, localized, or micrometeorology is the study of atmospheric phenomena and conditions smaller than mesoscale, about one kilometer (about 0.6 mi) or less.

Embodiments disclosed herein enable the prediction of localized climate conditions via a machine learning model given inputs such as synoptic scale, mesoscale, and/or storm scale water environmental or weather forecast parameters or actual conditions (e.g., a temperature, a heat exposure index, an insolation, a wind speed, a wind direction, a cloud cover, an atmospheric pressure, a precipitation amount, a wind chill, a dewpoint, a humidity, an atmospheric electrical field, a wind shear, an accumulated irradiation, a level of a pollutant, a level of a nutrient, or a phase of a celestial body such as the moon, sun, or nearby planet). These may be referred to as regional conditions (e.g., actual water environmental data, either live or historical), regional predictions (a forecast of conditions), and/or regional water environmental data (encompassing both actual conditions and forecasts) throughout this disclosure. A localized climate area may be an area with similar characteristics and water environmental conditions or weather conditions, e.g., a beach or a section of a beach.

As used herein, a localized environmental characteristic 124 is meant to encompass a physical aspect of the area in which a localized climate condition occurs (i.e., localized climate area). Examples of localized environmental characteristic 124 include, but are not limited to, composition of the shore area (e.g., sand, rocks, dunes, etc.), shading, windbreaks, surf breaks (e.g., reefs or shoals), the steepness of the shore, tidal conditions, reflectivity, transmissibility, and absorptivity of light of any wavelength (e.g., light colored sand vs. dark colored sand), heat capacity, type and amount of paving, presence or absence of plants, the shape of objects in the littoral area, features or properties of a surface, the characteristics of the nearby water such as temperature, salinity, turbidity, flowing vs still, etc.

As used herein, localized climate conditions are meant to encompass local water environmental conditions and weather conditions within the localized climate area. Examples of localized climate conditions include, but are not limited to, wave height, wave energy, wave frequency or periodicity, water and air temperatures, the likelihood of conditions such as rip currents, undertow, tidal patterns, wind speed and direction, swell direction, water turbidity, salinity levels, ultraviolet (UV) radiation intensity, precipitation levels, seaweed presence, marine debris, jellyfish or marine life activity, water pH level, algae bloom occurrences, bacterial contamination risks, potential for storm surges, insolation, wind speed, wind direction, cloud cover, atmospheric pressure, precipitation amount, wind chill, dewpoint, humidity, the atmospheric electrical field, wind shear, accumulated irradiation, a level of a pollutant, and/or combinations of these.

In some examples, a localized climate area may be an area within about one kilometer (about 0.6 mi) of a certain point and having one or more similar characteristics and/or water environmental conditions or weather conditions. In other examples, a localized climate area may be more compact, such as extending a few hundred feet, or even tens of feet or less, with similar characteristics throughout. A localized climate area may be continuous, or may be fragmented (e.g., one localized climate area separating two separate regions within another localized climate area. Localized climate areas may be static over time, or may shift over time, e.g., as the sun moves through the sky, as the tides or winds change, etc. Additionally, or alternately, localized environmental characteristics may shift over time. For example, a localized climate area may have had the beach eroded by a storm, which has changed the nature of the surf conditions, sometimes permanently.

In some embodiments, a water environmental prediction system receives local water environmental or weather condition data from the localized climate area, or a representative localized climate area (i.e., a localized climate area similar to the one for which a prediction is being made.) In some examples, a system includes a trained machine learning model that translates regional water environmental or weather information into localized environmental localized climate conditions. The machine learning model includes various characteristics of the localized climate area, (e.g., type of shore), used to predict the likely conditions in the localized climate area.

For example, a water environmental prediction system may calculate a likelihood of the presence of rip currents in the localized climate area from regional environmental data, localized climate area characteristics, and/or localized climate conditions in the localized climate area or in a representative localized climate area. Those conditions can be relayed to a user such as through a user device like a smart phone, etc. For example, a predicted rip current risk may be classified as high risk, where strong and frequent rip currents are expected, and swimming is discouraged. One reason for this value may be the height of the surf in the localized climate area. Later, the surf may decrease in size causing the rip current risk to lessen in the localized climate area. If a user of a water environmental prediction system is aware of these conditions before they occur, it enables them to be proactive and plan accordingly, such as by changing schedules or taking mitigating actions.

In some examples, the system may be trained by receiving the localized climate conditions from the sensors in the localized climate area and comparing and correlating that local sensor data with corresponding regional forecast and/or water environmental condition or weather condition data (i.e., regional data). For example, a beach may have localized environmental characteristics defined by the type of shore, wind, and tidal characteristics, etc. This localized climate area may have one or more local sensors installed therein that capture localized climate conditions (e.g., temperature, surf height, wind, precipitation, etc.). The local sensor data, regional water environmental or weather data, and/or characteristics of the localized climate area (i.e., training data) may be fed into a model such as a machine learning (“ML”) model or algorithm. The ML model may be trained with the inputted data and/or characteristics to develop correlations between the local sensor data, regional water environmental or weather data, localized climate conditions 110, and the localized climate area characteristics.

In some embodiments, the ML model may be trained to make the predictions regarding the localized climate conditions 110 in the localized climate area 112a based on computer vision without additional types of sensors. For example, the ML model may initially be trained on both wave height data from a local sensor 116 coupled to a buoy 102 as well as video or photographic data of wave conditions. During the training, the ML model may learn to correlate the video or photo data to the wave height data. Once trained, the ML model may be able to predict localized climate conditions 110 in the localized climate area 112a based on the photo or video data alone, without other sensors such as a wave height sensor.

In one specific example, such as where the ML model is a neural net, the training data may be used to develop weightings between “neurons” of the ML model. In some examples, the ML model may be a “digital twin” of the localized climate area. In some examples, a digital twin is a virtual representation of a localized climate area that spans its lifecycle, is updated from real-time data, and uses simulation, machine learning, artificial intelligence, and/or reasoning to help decision making. The digital twin may have a high level of precision in the structure, materials, and other characteristics of the localized climate area. For example, a digital twin may not only represent dunes, cliffs, shoals, beaches, etc.

The trained ML model may be used to develop predictions of localized climate conditions 110 in the localized climate area on which it was trained, and for other localized climate areas with similar characteristics, with or without local sensor data. Continuing the beach example, if the ML model is trained on a particular beach in Massachusetts, the trained ML model may be used to predict localized climate conditions 110 in other beaches with similar localized climate area characteristics (e.g., shore type, tide, wind, precipitation, etc.) in Massachusetts, and/or in other locations with similar macroclimate characteristics (e.g., elevation, latitude, longitude, type of nearby bodies of water, etc.). The ML model may also be able to adapt to situations where localized climate area characteristics are dissimilar between two localized climate areas. For example, comparing two different beaches, one may have darker sand that absorbs heat more readily than a beach with relatively lighter sand. The ML model may adjust its predictions of localized climate conditions 110 based on the color of the sand and other differences in characteristics.

For example, the ML model may output the localized climate conditions 110 described herein. These conditions may be significantly different than the conditions predicted by a national, regional, or even local water environmental or weather forecast. The system may generate a warning to users of the conditions expected in the localized climate area. The system may advise users to take precautions to adapt to the water environmental or weather, such as avoiding swimming, taking alternate routes to shore in a watercraft, etc.

The systems and methods described herein are not limited to shore, water, or littoral environments, but are broadly applicable to a variety of additional scenarios beyond those specifically depicted. For instance, within the field of infrastructure and urban planning, the system may be utilized for urban flood forecasting, storm water management, and assessment of coastal infrastructure vulnerability, including but not limited to predictive modeling of water levels, wave action, and impacts from extreme weather events to support resilient city planning and emergency preparedness.

In agriculture and irrigation management, the described system may be configured to optimize irrigation schedules, predict and reduce water consumption, assess drought risk, and improve overall crop management by analyzing environmental inputs and evapotranspiration rates.

In the realm of public health and safety, the system may be employed to monitor the likelihood of waterborne pathogen outbreaks, forecast harmful algal bloom events, and provide advance warning for vector-borne disease conditions arising from changes in water and weather.

For renewable energy applications, the system is suited for hydropower, wind, and solar energy generation support, etc. It may be implemented to forecast resource availability, optimize operational scheduling, and inform grid management through predictive analytics for river flow, wind patterns, and solar irradiance.

Additionally, the system offers utility in diverse transportation sectors. In the aviation environment, the system may forecast turbulence, icing, and runway contamination. In rail transport, the system may predict track washouts or weather-induced obstructions. Road transportation applications may include hydroplaning risk assessment and fog forecasting.

Further, the system is applicable in emergency response and disaster management contexts by projecting storm surge, tsunami events, and flash flood risks, facilitating evacuation and resource allocation strategies.

In environmental and ecological monitoring, the system may be used to track habitat conditions, model the effects of climate change on aquatic and terrestrial environments, and forecast the migratory or behavioral patterns of species dependent on water and atmospheric conditions.

Recreational and tourism applications include forecasting water quality, temperature, and meteorological conditions relevant to beach safety, boating, fishing, and water sports.

In industrial and facility management, the system is adaptable for the prediction and monitoring of onsite weather hazards, cooling and process water requirements, and the impacts of wastewater discharge.

It is understood that the foregoing examples are illustrative and are intended to demonstrate the extensibility of the claimed system and methods across a broad and non-limiting range of practical uses.

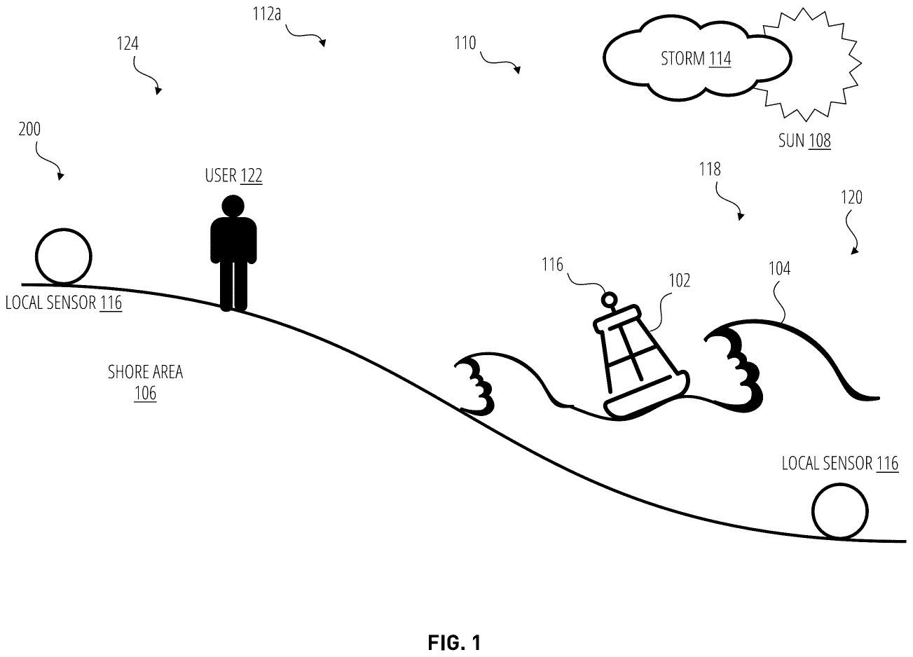

Turning to the figures, FIG. 1 shows an example of a localized climate area 112a. The localized climate area 112a includes a littoral area 118 of a body of water 120 and an adjacent shore area 106. The localized climate area 112a is subject to varying localized climate conditions 110 such as surf or waves 104, storms 114, sun 108, wind, tide, precipitation, etc. FIG. 1 shows portions of a water environmental prediction system 200 such as a local sensor 116 placed under water in the body of water 120, a buoy 102 including a local sensor 116 (such as a sensor that detects localized environmental characteristics of the waves 104, etc.), and a local sensor 116 in the shore area 106. A user 122 of the localized climate area 112a, such as a beachgoer, is shown.

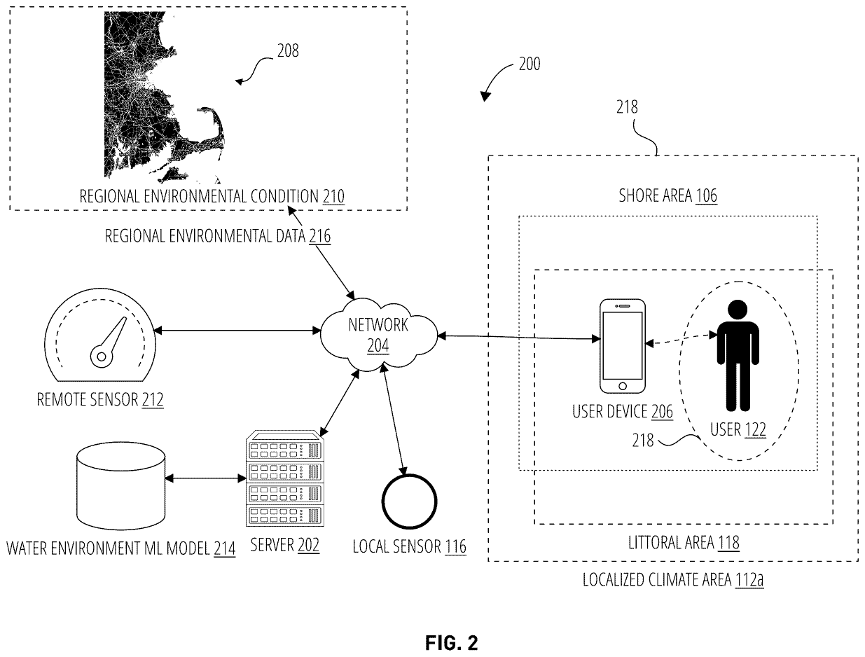

Turning to the figures, FIG. 2 is a schematic of a water environmental prediction system 200. The water environmental prediction system 200 includes a server 202 and a water environment ML model 214. In some embodiments, the water environmental prediction system 200 may include a user device 206, a network 204, a local sensor 116, and/or a remote sensor 212.

The user device 206 may be any device capable of communicating with other elements of the water environmental prediction system 200, such as a smart phone, tablet, laptop computer, desktop computer, smart watch, control console, etc. In many examples, the user device 206 may communicate via wired or wireless communications to other elements of the water environmental prediction system 200 through the network 204. In some examples, the user device 206 may communicate directly with other elements of the water environmental prediction system 200 without using a network 204.

The network 204 may be implemented using one or more of various systems and protocols for communications between computing devices using either wired or wireless methods. In various embodiments, the network 204 or various portions of the network 204 may be implemented using the Internet, a local area network (LAN), a wide area network (WAN), and/or other networks. In addition to traditional data networking protocols, in some embodiments, data may be communicated according to protocols and/or standards including near field communication (NFC), Bluetooth, cellular connections, Wi-Fi, Zigbee, and the like.

The water environmental prediction system 200 may receive inputs pertaining to a regional area such as a forecast 208 and/or a regional environmental condition 210, such as via a network 204. Typically, a regional area may extend more than a kilometer and may have many different characteristics throughout. A regional area may typically be, a large area, such as a continent, country, city, state, province, or other broad region up to and including the entire Earth and even space weather. The regional area may include one, or often, many localized climate areas, such as a localized climate area 112a and a localized climate area 112b. The forecast 208 may be a prediction of one or more weather conditions in a regional area, such as generated by the U.S. National Weather Service, similar governmental services that predict weather for other countries or other entities (including private companies) that predict weather. The regional environmental condition 210 may represent the regional environmental data 216 collected by one or more remote sensors 212, such as by a weather station, within the regional area. In other words, a forecast 208 is a prediction of future conditions, whereas a regional environmental condition 210 is an actual condition recorded by a remote sensor 212.

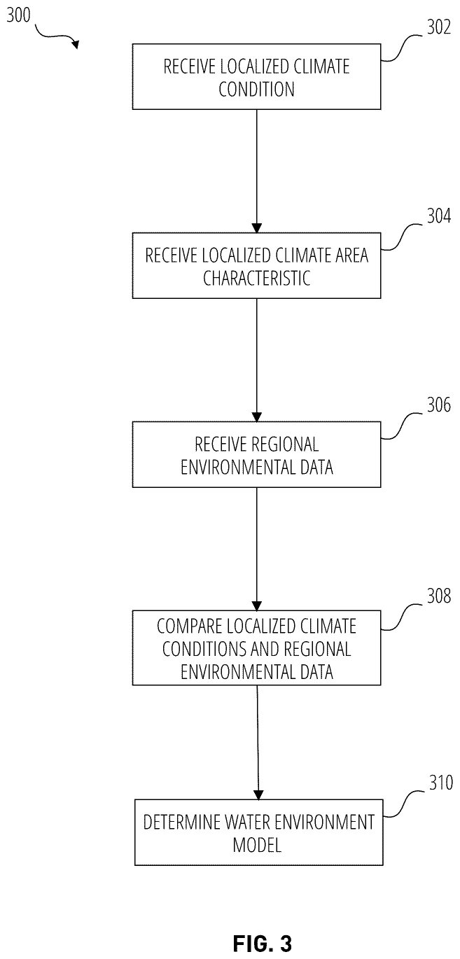

The water environmental prediction system 200 is configured to predict one or more localized climate conditions 110 in the localized climate area 112a. The water environmental prediction system 200 includes a water environment ML model 214. The water environment ML model 214 may be an ML model or artificial intelligence (“AI”) model executed by a computing system 700 of the server 202. The water environment ML model 214 may be trained to predict one or more localized climate conditions 110. The training of the water environment ML model 214 may be based on the forecast 208, the regional environmental condition 210 (including data from a remote sensor 212, such as the regional environmental data 216), data from one or more local sensors 116, and/or characteristics of the localized climate area 112a. Training of the water environment ML model 214 is discussed in more detail with respect to FIG. 3 and the method 300.

The water environment ML model 214 may be implemented using various machine learning architectures. Three non-limiting examples of suitable architectures are described below.

In a first example, the water environment ML model 214 is a multimodal neural network including input encoders, feature-fusion layers, and prediction heads. The input encoders are separate modules that process different data types, such as regional weather data (including temperature forecasts, sunlight levels, wind, atmospheric pressure, humidity, precipitation, and cloud cover), local sensor data (such as wave height, water temperature, salinity, turbidity, images, and audio recordings of surf or wind), and local environmental characteristics (including beach slope, shoreline composition, surf break shape, and tidal patterns). Feature-fusion layers combine all processed inputs into a single unified picture representing the system's environmental state. The prediction heads produce final outputs pertaining to water and climate conditions, such as wave height, rip current risk, turbidity, UV index, storm surge risk, algae bloom likelihood, and other metrics. Each encoder may operate as follows: the regional data encoder uses a sequence model (such as a recurrent neural network) that processes time-ordered weather data, enabling recognition of temporal patterns including tides, storm fronts, and daily heating and cooling cycles. The local sensor data encoder uses convolutional or convolutional-recurrent neural architectures to make sense of readings from multiple buoys 102 or shoreline devices, producing an understanding of local water movement and conditions. The visual data encoder processes images or three-dimensional sensor data (for example, from cameras or LIDAR), extracting visual information such as wave shape or foam patterns that may indicate hazardous conditions. Additionally, the model incorporates a learned embedding representing each specific beach or local environment; this embedding captures relatively fixed features such as beach slope, surf break geometry, shoreline composition, and the historical behavior of that beach, allowing identical regional weather conditions to produce different local predictions at different beaches. The model's prediction heads output one or more localized climate conditions 110, including but not limited to wave height, wave energy, wave frequency, rip current risk, undertow risk, tidal pattern classification, UV exposure at the shore, precipitation at the shore, water turbidity, salinity, marine debris levels, algae bloom likelihood, bacterial contamination risk, and storm surge risk. Some prediction heads generate risk scores or risk categories (for instance, “high rip current risk” or “dangerous surf”), which the water environmental prediction system 200 can use to trigger alerts or safety recommendations.

In a second example, the water environment ML model 214 uses a transformer architecture. The transformer-based water environment ML model 214 processes sequential and multimodal inputs using self-attention mechanisms to capture temporal and spatial dependencies in the regional environmental data 216 and local sensor 116 data. The transformer architecture includes an input embedding layer that converts regional environmental data 216 (such as forecast 208 data, temperature, wind speed, atmospheric pressure, humidity, and precipitation) and local sensor 116 data (such as wave height, water temperature, salinity, and turbidity readings from buoys 102 or underwater sensors) into high-dimensional vector representations. Positional encodings are added to the input embeddings to preserve temporal ordering of the data, enabling the model to recognize patterns across different time scales (e.g., hourly, daily, tidal cycles, and seasonal variations). The transformer encoder may include multiple stacked layers, each of which may contain multi-head self-attention mechanisms and feed-forward neural networks. The multi-head self-attention mechanisms allow the model to attend to different portions of the input sequence simultaneously, capturing relationships between regional weather patterns and localized climate conditions 110 across varying time lags. For example, the attention mechanism may learn to correlate offshore wind patterns from regional environmental data 216 with subsequent wave height conditions in the localized climate area 112a. Cross-attention layers may be employed to fuse information from different data modalities, such as combining regional forecast 208 data with real-time local sensor 116 readings. The transformer includes a decoder that generates predictions for localized climate conditions 110, including wave height, rip current likelihood, water turbidity, UV radiation intensity, and storm surge risk. The decoder may utilize autoregressive generation to produce multi-step forecasts, predicting localized climate conditions 110 for multiple future time intervals. Localized climate area characteristics (such as shore type, beach slope, and surf break geometry) may be incorporated as conditioning inputs or learned embeddings that modulate the transformer's attention patterns, enabling the model to produce location-specific predictions from regional environmental data 216.

In a third example, the water environment ML model 214 is a diffusion model that takes in sensor and forecast data and uses a diffusion noising/denoising process to generate localized climate conditions 110 for the localized climate area 112a. The diffusion-based water environment ML model 214 operates through a forward diffusion process and a reverse denoising process. During the forward diffusion process, the model progressively adds Gaussian noise to training samples of localized climate conditions 110 over a series of timesteps, gradually transforming the data distribution into a known noise distribution. During the reverse denoising process, the model learns to iteratively remove noise from a noisy sample, conditioned on the regional environmental data 216 and local sensor data, to generate predictions of localized climate conditions 110. The diffusion model receives conditioning inputs including regional environmental data 216 (such as forecast 208 data comprising temperature, wind speed, wind direction, atmospheric pressure, humidity, precipitation, and cloud cover from sources such as the U.S. National Weather Service or similar services), local sensor 116 data (such as wave height, water temperature, salinity, turbidity, and current patterns from local sensors 116 positioned in the localized climate area 112a, including land-based sensors, buoy-based sensors, and underwater sensors), and localized climate area characteristics (such as shore composition, beach slope, surf break geometry, tidal patterns, and historical behavioral profiles of the localized climate area 112a). The conditioning inputs are encoded using neural network encoders (such as convolutional neural networks for spatial data, recurrent neural networks or transformers for temporal sequences, and embedding layers for categorical attributes) and concatenated or cross-attended with the noisy sample at each denoising step. The denoising network, which may be implemented as a U-Net architecture with attention mechanisms to segment image data into different parts of the localized climate area 112a (e.g., surf, beach, sky, etc.), predicts the noise component at each timestep, enabling iterative refinement of the localized climate condition 110 predictions. The diffusion model generates predictions for localized climate conditions 110 including wave height, wave energy, wave frequency, rip current risk, undertow risk, tidal patterns, water turbidity, salinity levels, UV radiation intensity, precipitation levels, marine life activity, algae bloom occurrences, bacterial contamination risks, and storm surge likelihood, etc.. The diffusion model's iterative denoising process enables the generation of probabilistic predictions, allowing the water environmental prediction system 200 to quantify uncertainty in the predicted localized climate conditions 110 and generate alerts with associated confidence levels. The diffusion model may be trained on historical data correlating regional environmental data 216 with observed localized climate conditions 110 in the localized climate area 112a, enabling the model to learn the complex relationships between regional weather patterns and localized environmental phenomena.

In one example, the localized climate area 112a may include the shore area 106 and the littoral area 118. The shore area 106 and the littoral area 118 may partially overlap or may be separate from one another.

In operation, the water environmental prediction system 200 may receive various inputs such as a forecast 208, regional environmental condition 210, and optionally, data from a remote sensor 212 and/or a local sensor 116. In many examples, the water environmental prediction system 200 makes its prediction based on the forecast 208 and/or the regional environmental condition 210 without any data from a local sensor 116. The water environmental prediction system 200 may, based on the inputs, determine one or more predicted localized climate conditions 110. Some non-limiting examples of a localized climate condition 110 include, but are not limited to, wave height, wave energy, wave frequency or periodicity, water and air temperatures, the likelihood of conditions such as rip currents, undertow, tidal patterns, wind speed and direction, swell direction, water turbidity, salinity levels, ultraviolet (UV) radiation intensity, precipitation levels, seaweed presence, marine debris, jellyfish or marine life activity, water pH level, algae bloom occurrences, bacterial contamination risks, potential for storm surges, insolation, wind speed, wind direction, cloud cover, atmospheric pressure, precipitation amount, wind chill, dewpoint, humidity, the atmospheric electrical field, wind shear, accumulated irradiation, a level of a pollutant, and/or combinations of these.

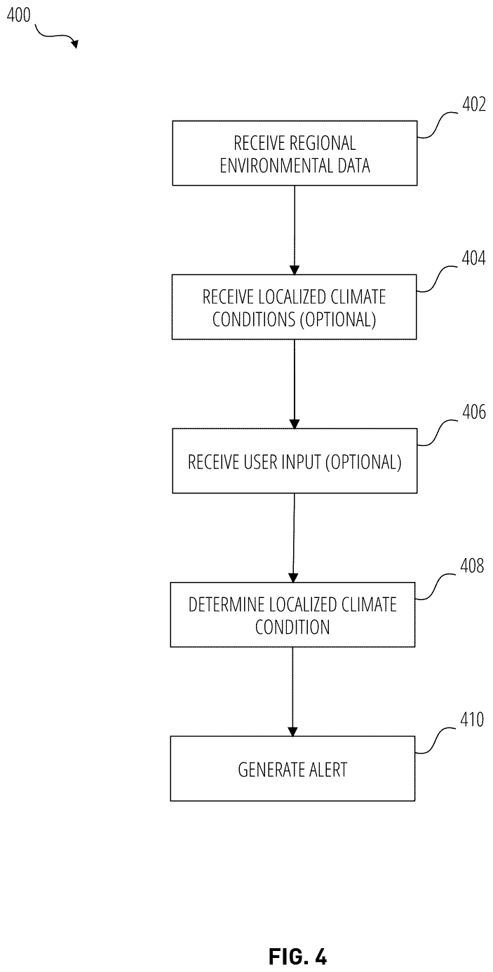

Operation of the water environmental prediction system 200 is discussed in more detail with respect to FIG. 4 and the method 400.

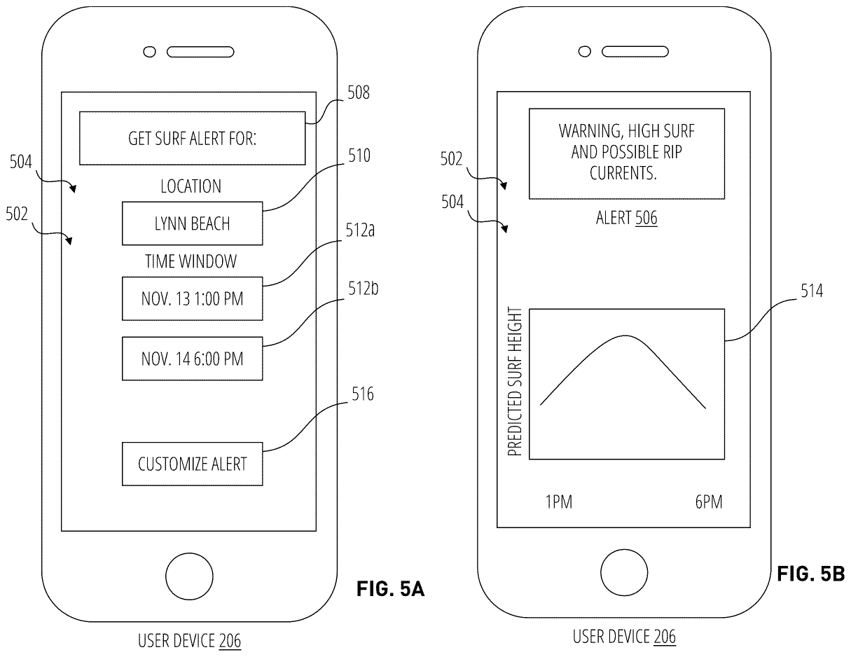

The water environmental prediction system 200 may generate an alert (see, e.g., FIG. 5B) based on the localized climate condition 110. For example, if the water environmental prediction system 200 predicts a high possibility of rip currents in the localized climate area 112a/b, the water environmental prediction system 200 may transmit the alert to a device associated with a user 122, such as a user device 206. The alert may warn the user 122 to take precautions against the localized climate condition 110 (e.g., avoid going in the water). In some embodiments, the alert may be a real time alert generated as conditions change in the localized climate area 112a/b.

In some embodiments, a geofence may be defined to encompass all or part of a specific localized climate area, such as a beach. When a user device 206 enters the geofence 218 boundary, the water environmental prediction system 200 may detect the device's presence within the localized climate area 112a/b. Responsive to this detection, microclimate-specific information or alerts may be delivered to the user 122, including real-time environmental conditions (e.g., temperature, humidity, UV index, wind speed, etc.), safety alerts, and other location-relevant data. The geofence 218 may be established and managed using GPS or other suitable positioning technologies, thereby enabling automated, context-aware dissemination of localized climate information to users as they enter or interact with the geofenced microclimate area.

In some embodiments, the geofence 218 may travel with the user 122 or user device 206. For example, as a user 122 strolls down a beach, the water environmental prediction system 200 may define a zone around the user that acts as a geofence 218. This type of geofence 218 may be any shape. For example, the geofence 218 may be a defined distance away from the user in one or more directions, in either two dimensions (e.g., a circle, rectangle, square, etc.) or three dimensions (e.g., a sphere, prism, or cube, etc.) As the user moves, the water environmental prediction system 200 may continually update the alerts 506 and other information delivered to the user 122 based on the user 122 geofence 218 location.

FIG. 3 illustrates an example of a method 300 for training a water environment ML model 214 of the water environmental prediction system 200. Although the example method 300 depicts a particular sequence of operations, the sequence may be altered without departing from the scope of the present disclosure. For example, some of the operations depicted may be performed in parallel or in a different sequence that does not materially affect the function of the method 300. In some examples, the method 300 may be executed by a single device, while in other examples, the method 300 may be distributed across different devices (e.g., server 202, the user device 206, the remote sensor 212, and/or the local sensor 116) with each device performing a part or all of the method 300. In some examples, the method 300 may be executed by different components of an example device of the water environmental prediction system 200 that implements the method 300. In some examples, the operations of the method 300 may be performed at substantially the same time or in a specific sequence.

The method 300 begins by the water environmental prediction system 200 receiving localized climate conditions 110 at operation 302. The data may include information about one or more localized climate conditions 110 in a localized climate area, such as the localized climate area 112a. The localized climate conditions 110 may be received or generated by one or more local sensors 116. Local sensors 116 may measure localized climate conditions 110 as described herein. The data related to the localized climate conditions 110 may be received by the server 202, either through a direct connection to the local sensors 116, or via the network 204. In some examples, the localized climate conditions 110 are live or near-live conditions, while in other examples, the localized climate conditions 110 are historical.

The method 300 may proceed to operation 304 and the water environmental prediction system 200 receives one or more localized climate area characteristics. For example, the water environmental prediction system 200 may receive data related to: the type of shore (e.g., surf, pebble, rock, cliff, etc.), tidal data, water current data, etc. In some examples, the data related to the localized climate area characteristics may be received by the server 202, either through a direct connection, or via the network 204.

The method 300 may proceed to operation 306 and the water environmental prediction system 200 receives regional environmental data 216. As discussed, the regional environmental data 216 may include either or both a regional forecast 208 (e.g., predictions of future weather) and/or a regional environmental condition 210 (e.g., actual conditions, either in real-time or historical). For example, the water environmental prediction system 200 may receive a regional environmental condition 210 from a public service (e.g., the U.S. National Weather Service or a corresponding national weather service of any country or region), a private service or both. Historical regional environmental conditions 210 may be received from weather or climate archives maintained by an organization such as the U.S. National Oceanic and Atmospheric Administration, and/or similar governmental or private organizations. The regional environmental data 216 may be received by the server 202 of the water environmental prediction system 200 via the network 204 such as through an application program interface, a manual download of data, or other suitable methods. The regional environmental data 216 may be received in real time, near real time, or historically. The regional environmental data 216 may be developed using remote sensors 212 that measure any aspect of weather, including satellite or terrestrial sensors, and radar, sonar, and the like.

The method 300 may proceed to operation 308 and the water environmental prediction system 200 compares the localized climate conditions 110 with the regional environmental data 216 for given localized climate area 112a. For example, in the operation 308, the server 202 or other computing system 700 may compare the regional environmental data 216 with the local sensor 116 data, accounting for the localized climate area characteristics 110 to find correlations therebetween. The operation 308 may use many sets of data at any time of day, through a year, and/or over a span of days, weeks, months, years, decades, and/or centuries.

The method 300 may proceed to operation 310 and the water environmental prediction system 200 determines the water environment ML model 214. For example, in cases where the water environment ML model 214 is a neural net, the water environmental prediction system 200 may develop weighting data for neurons of the neural net based on the comparison and correlation performed in the operation 308. The water environmental prediction system 200 may use the water environment ML model 214, for example as described with respect to the method 400 to predict one or more localized climate conditions 110. In some examples, the water environment ML model 214 represents a digital twin of the localized climate area. In some examples, the digital twin includes a multi-physics model of the localized climate area representing heat generation and flow, fluid dynamics (e.g., wind, tidal, and water) simulations, thermodynamics, traffic movement (e.g., of people, animals, and/or vehicles), optics (e.g., raytracing of sunlight and reflections thereof), three-dimensional solid and/or surface modeling (e.g., of the shore area 106 or littoral area), etc.

FIG. 4, FIG. 5A, and FIG. 5B illustrate an example of a method 400 for predicting a localized climate condition 110 using the water environmental prediction system 200. Although the example method 400 depicts a particular sequence of operations, the sequence may be altered without departing from the scope of the present disclosure. For example, some of the operations depicted may be performed in parallel or in a different sequence that does not materially affect the function of the method 300. In some examples, the method 400 may be executed by a single device, while in other examples, the method 400 may be distributed across different devices (e.g., server 202, the user device 206, the remote sensor 212, and/or the local sensor 116) with each device performing a part or all of the method 300. In some examples, the method 300 may be executed by different components of an example device of the water environmental prediction system 200 that implements the method 300. In some examples, the operations of the method 300 may be performed at substantially the same time or in a specific sequence.

The method 400 may begin in operation 402 and the water environmental prediction system 200 receives regional environmental data 216. The operation 402 may be substantially similar to the operation 306 described herein, but with an emphasis on live or near-live regional environmental data 216 (e.g., both live conditions and forecasts 208). For example, in the operation 402, the water environmental prediction system 200 may receive regional environmental data 216 for one or more regions that contain a particular localized climate area 112a of interest. In some examples, the water environmental prediction system 200 may receive regional environmental data 216 for regions that may affect the localized climate area 112a. For example, if the localized climate area 112a is in Massachusetts (e.g., a portion of Lynn Beach), the water environmental prediction system 200 may receive regional environmental data 216 for Massachusetts, but may also receive regional environmental data 216 for regions to the south of Massachusetts such as Florida, Texas, or other states that border major bodies of water, etc.

The method 400 may continue to operation 404 and the water environmental prediction system 200 receives localized climate conditions, e.g., from one or more local sensors 116. In some examples, the operation 404 is optional and the water environmental prediction system 200 operates without any input from local sensors 116. In many examples, the operation 404 is substantially similar to the operation 302, but with an emphasis on live, real-time, or near real time localized climate conditions.

The method 400 may continue to operation 406 and the water environmental prediction system 200 receives user input, e.g., from a user device 206. As shown for example in FIG. 5A, the user device 206 may execute an application 502 that displays a user interface 504. The user interface 504 may display a prompt 508 that notifies the user 122 that the application 502 is requesting input from the user 122. The user interface 504 may also include one or more inputs such as a location input 510 and one or more time inputs 512a, 512b. In the example shown in FIG. 5A, a user 122 is requesting that the water environmental prediction system 200 predict the localized climate conditions 110 for Lynn Beach in Massachusetts (e.g., via the location input 510) for times between 1 PM on November 13 and 6 PM on November 14 (e.g., via the time input 512a and time input 512b, respectively). The user 122 may submit an alert request such as by pressing a user input 516 button of the user interface 504. The user device 206 may transmit the user request to the server 202, such as via the network 204, and the server 202 may determine the localized climate condition during the requested times and days using the water environment ML model 214. In some examples, the operation 406 is optional and the water environmental prediction system 200 may generate predictions of a localized climate condition on an ongoing or scheduled basis. In some embodiments, the water environmental prediction system 200 can generate an alert based on a geolocation or proximity of a user 122 to the localized climate area 112a. In examples where the water environmental prediction system 200 implements a geofence 218, the user input may include the location of the user 122 or the user device 206 within the geofence 218 but with insufficient accuracy to pinpoint the user's 122 location. For example, the water environmental prediction system 200 may be aware that a user 122 is within a particular geofence or that they have crossed into a geofence 218 area and have not left it, but the water environmental prediction system 200 may not know the user's precise location in the geofence 218. The user 122 may control whether their location is shared with the water environmental prediction system 200 and thus such user inputs may be optional.

The method 400 may continue to operation 408 and the water environmental prediction system 200 determines a localized climate condition. For example, the water environmental prediction system 200 may input data received in the operation 402 and optionally the operation 404, and/or the user request received in operation 406 into the water environment ML model 214. The water environment ML model 214 analyzes the regional environmental data and one or more localized climate area characteristics of a localized climate area to translate the regional environmental data into the localized climate conditions 110 for the localized climate area.

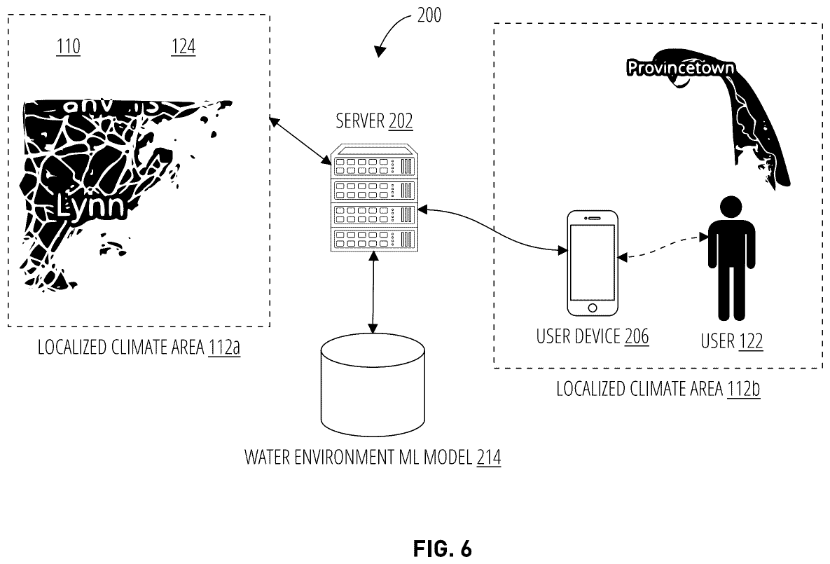

The localized climate conditions 110 may be for a localized climate area on which the water environment ML model 214 was trained or may be a different localized climate area (e.g., as discussed with respect to FIG. 6). The localized climate condition may be for the current time (e.g., a real-time determination of a condition in the localized climate area 112a). Alternately, or additionally, the localized climate condition may be a forecast for a localized climate condition sometime in the future, such as a few minutes ahead of the current time, hour ahead, several hours, several days, weeks, or months. The forecast localized climate condition may correspond to a certain event, such as sunset, sunrise, etc. In some examples, a user 122 may request that the water environmental prediction system 200 predict the localized climate condition for a desired time and/or day. For example, if the user 122 is in charge of a surfing event, or other activity scheduled to start at 1 PM on November 13, the user 122 may request that the water environmental prediction system 200 predict the localized climate condition for the time of the event, e.g., as discussed with respect to the operation 406 and FIG. 5A.

The method 400 may continue to operation 410 and the water environmental prediction system 200 generates an alert related to the localized climate condition. See, e.g., FIG. 5B. For example, the server 202 may generate an alert 506 message based on the water environment ML model 214 prediction of the localized climate condition 110. The server 202 may transmit the alert 506 to the user device 206 which may display the alert via the user interface 504. In the example shown in FIG. 5B, the alert 506 says, “Warning, high surf and possible rip currents.” In some examples, the alert 506 may include data such as predicted values for one or more localized climate conditions 110. These conditions may be presented in a chart 514 or tabular form (e.g., versus time), as shown for example in FIG. 5B. In some examples, the alert 506 may be displayed on dynamic signage, such as above roadways, streets, at a beach, or at facilities. The alerting operation 410 may focus on real-time conditions and future forecasts, notifying on-site users to help make timely decisions. This may be achieved by developing alerting rules based on live atmospheric conditions which will enable flagging of beach and surf conditions for warning users of hazardous conditions. The operation 410 may be accomplished via any one or more of the following: sensors (local sensor 116 and/or remote sensors 212), video, radar, surf monitoring sensors (e.g., buoys 102), or video analytics monitoring the waves 104. The alert 506 may optionally be based on a geofence 218 associated with the localized climate area 112a/b and/or a geofence that travels with the user 122. For example the user 122 may receive alerts for a particular localized climate area 112a/b when they enter that localized climate area. In another example, the water environmental prediction system 200 and the method 400 may update the alerts received by the user based on a geofence 218 that travels with the user 122.

Using the water environmental prediction system 200, the method 300, and method 400, the user may make plans to accommodate for, or otherwise mitigate, undesirable or uncomfortable localized climate conditions.

With reference to FIG. 6, the water environmental prediction system 200 may be configured to predict localized climate conditions 110 in one localized climate area 112b (e.g., a portion of a beach in Provincetown, Massachusetts) based on training data from a localized climate area 112a (e.g., a portion of Lynn Beach) different than the localized climate area 112b. In the example shown, the water environmental prediction system 200 may have been trained, at least partly, on local sensor 116 data from the Lynn Beach localized climate area 112a such as described with respect to the method 300. The localized climate area 112a and localized climate area 112b may be exposed to similar or different surf conditions from the Atlantic Ocean. In another example, the localized climate area 112a may be a first portion of a shore area 106 and the localized climate area 112b may be another portion of the same shore area 106. For example, the localized climate area 112a may be a portion of Lynn Beach, and the localized climate area 112b may be a different portion of Lynn Beach about a hundred feet away from the localized climate area 112a. The localized climate area 112b may face a different direction, have different tidal patterns, and/or different surf conditions, etc. compared to the localized climate area 112a. Based on differences between the localized climate area localized environmental characteristics in the localized climate area 112a and the localized environmental characteristics of the localized climate area 112b, the water environmental prediction system 200 may predict the localized climate conditions 110 in the localized climate area 112b. For example, the water environment ML model 214 may account for differences in shore type, wind exposure, tides, vegetation, etc. between the localized climate area 112a and the localized climate area 112b. In some examples, the localized climate area 112a may include one or more local sensors 116 that the water environmental prediction system 200 uses (e.g., in operation 404) to aid in the prediction of the localized climate conditions 110 in the localized climate area 112b. This data may help inform the determination of the localized climate conditions 110 in the localized climate area 112b, even though the local sensors 116 are not located in the localized climate area 112b. Thus, the water environmental prediction system 200 may be easily adapted to many different localized climate areas without the need to instrument each one with local sensors 116, thereby reducing cost and speeding the timeline and increasing the scale of the deployment of the water environmental prediction systems 200 for the benefit of users 122 as disclosed herein.

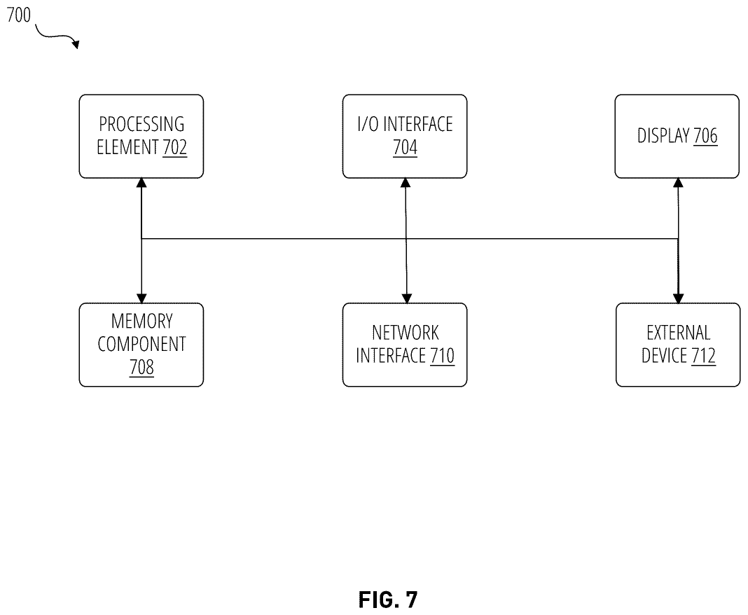

FIG. 7 is a simplified block diagram of components of a computing system 700 of the water environmental prediction system 200, such as the server 202, a local sensor 116, the user device 206, a remote sensor 212, etc. For example, the processing element 702 and the memory component 708 may be located at one or in several computing systems 700. This disclosure contemplates any suitable number of such computing systems 700. For example, the server 202 may be a desktop computing system, a mainframe, a blade, a mesh of computing systems 700, a laptop or notebook computing system 700, a tablet computing system 700, an embedded computing system 700, a system-on-chip, a single-board computing system 700, or a combination of two or more of these. Where appropriate, a computing system 700 may include one or more computing systems 700; be unitary or distributed; span multiple locations; span multiple machines; span multiple data centers; or reside in a cloud, which may include one or more cloud components in one or more networks. A computing system 700 may include one or more processing elements 702, an input/output I/O interface 704, one or more external devices 712, one or more memory components 708, and a network interface 710. Each of the various components may be in communication with one another through one or more buses or communication networks, such as wired or wireless networks, e.g., the network 204. The components in FIG. 7 are exemplary only. In various examples, the computing system 700 may include additional components and/or functionality not shown in FIG. 7.

The processing element 702 may be any type of electronic device capable of processing, receiving, and/or transmitting instructions. For example, the processing element 702 may be a central processing unit, microprocessor, processor, or microcontroller. Additionally, it should be noted that some components of the computing system 700 may be controlled by a first processing element 702 and other components may be controlled by a second processing element 702, where the first and second processing elements may or may not be in communication with each other.

The I/O interface 704 allows a user to enter data in to computing system 700, as well as provides an input/output for the computing system 700 to communicate with other devices or services. The I/O interface 704 can include one or more input buttons, touch pads, touch screens, and so on.

The external device 712 are one or more devices that can be used to provide various inputs to the computing systems 700, e.g., mouse, microphone, keyboard, trackpad, sensing element (e.g., a thermistor, humidity sensor, light detector, etc.). The external devices 712 may be local or remote and may vary as desired. In some examples, the external devices 712 may also include one or more additional sensors.

The memory components 708 are used by the computing system 700 to store instructions for the processing element 702 such as the water environment ML model 214, the application 502 and/or user interface 504, as well as store data, such as regional environmental data 216, localized climate conditions, localized climate area characteristics, user preferences, alerts, etc. The memory components 708 may be, for example, magneto-optical storage, read-only memory, random access memory, erasable programmable memory, flash memory, or a combination of one or more types of memory .components.

The network interface 710 provides communication to and from the computing system 700 to other devices. The network interface 710 includes one or more communication protocols, such as, but not limited to Wi-Fi, Ethernet, Bluetooth, etc. The network interface 710 may also include one or more hardwired components, such as a Universal Serial Bus (USB) cable, or the like. The configuration of the network interface 710 depends on the types of communication desired and may be modified to communicate via Wi-Fi, Bluetooth, etc.

The display 706 provides a visual output for the computing system 700 and may be varied as needed based on the device. The display 706 may be configured to provide visual feedback to the user 122 and may include a liquid crystal display screen, light emitting diode screen, plasma screen, or the like. In some examples, the display 706 may be configured to act as an input element for the user 122 through touch feedback or the like.

The present disclosure is characterized by its localized, real-time focus and the comprehensive suite of data sources feeding into its predictive ML model (e.g., the water environment ML model 214). This system distinguishes itself from conventional tide or wave forecast systems, which typically depend on generalized data, through the strategic deployment of sensors and the employment of advanced algorithms.

The systems and methods disclosed herein have many benefits over existing systems. For example, the systems may capture localized variations by utilizing sensors that obtain atmospheric and oceanic variables in distinct coastal microclimates or localized climate areas. This allows the system to account for small-scale fluctuations typically unnoticed by other systems. Furthermore, the systems and methods provide real-time, port-specific predictions by monitoring precise sea levels and wave patterns within confined port areas, resulting in highly localized predictions. These predictions are crucial for ensuring operational readiness and responding to changing conditions.

The system also supports erosion management and flood risk assessment. The disclosed data collection approach enables the disclosed embodiments to predict not only tidal conditions but also longer-term risks, such as erosion and flooding potential, thereby assisting environmental and urban planners in proactively addressing these challenges. By providing advanced notice of expected surf and beach conditions, disclosed systems empower users such as cruise line crews, coastal managers, lifeguards, and beachgoers to make informed decisions. The localized, real-time monitoring and alerting capability is achieved by using atmospheric and oceanic data to trigger alerts when concerning surf or beach conditions arise. This system sends notifications to users such as on-site decision-makers, facilitating timely responses and adaptive measures.

Moreover, the disclosed systems employ predictive ML models adaptable to shore or littoral locations worldwide, using inputs from buoys and other weather sensors to provide precise and actionable forecasts.

The water environment ML models disclosed include data collection from microclimate devices, such as beach weather sensors that measure air temperature, humidity, wind speed, and atmospheric pressure, along with underwater sensors that monitor water temperature, wave height, salinity, and current patterns. The collected data is aggregated into a centralized system, allowing for real-time updates on weather and surf conditions. Predictive analytics are applied to analyze historical data, resulting in surf condition predictions such as wave height, frequency, and direction, and weather forecasting, including predictions of temperature, humidity, and wind patterns over several hours or days. Alerts are generated based on predicted conditions, with customizable alerts allowing for personalized thresholds according to specific user requirements.

The disclosed systems and methods offer visualization and reporting functionalities through interactive maps and charts, showcasing real-time surf conditions and weather patterns, and generating detailed reports that include forecasts, safety advisories, and historical analyses. The user interface is enhanced with a user-friendly dashboard, compatible with mobile devices, ensuring accessibility for on-the-go access to beach conditions.

Any description of a particular component being part of a particular embodiment, is meant as illustrative only and should not be interpreted as being required to be used with a particular embodiment or requiring other elements as shown in the depicted embodiment.

All relative and directional references (including top, bottom, side, front, rear, and so forth) are given by way of example to aid the reader's understanding of the examples described herein. They should not be read to be requirements or limitations, particularly as to the position, orientation, or use unless specifically set forth in the claims. Connection references (e.g., attached, coupled, connected, joined, and the like) are to be construed broadly and may include intermediate members between a connection of elements and relative movement between elements. As such, connection references do not necessarily infer that two elements are directly connected and in fixed relation to each other, unless specifically set forth in the claims.

The present disclosure teaches by way of example and not by limitation. Therefore, the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

What is claimed is:

1. A method of predicting a localized climate condition comprising:
receiving, by a processing element, regional environmental data;
translating, by the processing element by utilizing a water environment machine learning model, the regional environmental data into the localized climate condition; and
generating, by the processing element, an alert based on the localized climate condition.

2. The method of claim 1, wherein the water environment machine learning model analyzes the regional environmental data and one or more localized climate area characteristics of a localized climate area to translate the regional environmental data into the localized climate condition for the localized climate area.

3. The method of claim 1, wherein the localized climate condition comprises one or more of: wave height, wave energy, wave frequency or periodicity, water and air temperature, rip current, undertow, tidal patterns, wind speed and direction, swell direction, water turbidity, salinity levels, ultraviolet (UV) radiation intensity, precipitation levels, seaweed presence, marine debris, marine life activity, water pH level, algae bloom occurrences, bacterial contamination risks, or storm surge.

4. The method of claim 1, wherein the alert comprises a mitigation action configured to mitigate effects of the predicted localized climate condition.

5. The method of claim 1, wherein the regional environmental data comprises at least one of a forecast or a regional weather condition.

6. The method of claim 5, wherein the regional weather condition comprises one or more of: a temperature, a heat exposure index, an insolation, a wind speed, a wind direction, a cloud cover, an atmospheric pressure, a precipitation amount, a wind chill, a dewpoint, a humidity, an atmospheric electrical field, a wind shear, an accumulated irradiation, a level of a pollutant, a level of a nutrient, or a phase of a celestial body.

7. The method of claim 5, wherein the regional weather condition comprises a real time or near real-time condition.

8. The method of claim 2, further comprising:
receiving, by the processing element, local weather data from a sensor located in the localized climate area, wherein the sensor is one or more of a land-based sensor, a buoy-based sensor, or an underwater sensor.

9. The method of claim 1, wherein the water environment machine learning model comprises an artificial intelligence or machine learning algorithm.

10. The method of claim 2, wherein the alert is based, at least in part, on a user's presence within a geofence.

11. The method of claim 10, wherein the geofence is correlated to the localized climate area, or the geofence travels with the user.

12. A method of training a machine learning model comprising:
receiving regional environmental data for a localized climate area;
detecting one or more localized climate conditions via one or more sensors positioned within the localized climate area;
determining one or more localized environmental characteristics of the localized climate area at the time of the detected one or more localized climate conditions;
generating the trained machine learning model based on the regional environmental data, the one or more localized climate conditions, and the one or more localized environmental characteristics.

13. The method of claim 12, wherein the trained machine learning model analyzes the regional environmental data and one or more localized climate area characteristics of the localized climate area to translate the regional environmental data into the one or more localized climate conditions for the localized climate area.

14. The method of claim 12, wherein the one or more localized climate conditions comprises one or more of: wave height, wave energy, wave frequency or periodicity, water and air temperature, rip current, undertow, tidal patterns, wind speed and direction, swell direction, water turbidity, salinity levels, ultraviolet (UV) radiation intensity, precipitation levels, seaweed presence, marine debris, marine life activity, water pH level, algae bloom occurrences, bacterial contamination risks, or storm surge.

15. The method of claim 12, wherein the regional environmental data comprises at least one of a forecast or a regional weather condition.

16. The method of claim 15, wherein the regional weather condition comprises one or more of: a temperature, a heat exposure index, an insolation, a wind speed, a wind direction, a cloud cover, an atmospheric pressure, a precipitation amount, a wind chill, a dewpoint, a humidity, an atmospheric electrical field, a wind shear, an accumulated irradiation, a level of a pollutant, a level of a nutrient, or a phase of a celestial body.

17. The method of claim 15, wherein the regional weather condition comprises a real time or near real-time condition.

18. The method of claim 12, further comprising generating an alert based on the one or more localized climate conditions.

19. The method of claim 18, wherein the alert is based, at least in part, on a user's presence within a geofence.

20. The method of claim 19, wherein the geofence is correlated to the localized climate area, or the geofence travels with the user.
